(19) United States
(12) Patent Application Publication
(10) Pub. No.: US 2006/0221488 A1
(43) Pub. Date: Oct. 5, 2006

(54) Multi-disk simultaneous servo writing device

(75) Inventors: Ericson V. Morales, Gilroy, CA (US); Li Zhang, Fremont, CA (US)

Correspondence Address: MICHAEL B. EINSCHLAG, ESQ., 25680 FERNHILL DRIVE, LOS ALTOS HILLS, CA, 94024, US

(73) Assignee: Riospring, Inc., Milpitas, CA (US)

(21) Appl. No.: 11/096,473

(22) Filed: Apr. 1, 2005

(51) Int. Cl. G11B 21/02; G11B 5/596

(52) U.S. Cl. 360/75; 360/78.04

(57) ABSTRACT

One embodiment of the present invention is a servo writing device that includes: (a) an actuator; (b) a first pushpin block that is coupled to a first side of the actuator and is adapted to drive a first head stack assembly during servo writing on a first disk; and (c) a second pushpin block that is coupled to a second side of the actuator and is adapted to drive a second head stack assembly during servo writing on a second disk.

### TECHNICAL FIELD OF THE INVENTION

One or more embodiments of the present invention relate to manufacturing disk drives, and more particularly, to devices for writing servo data on disks.

### BACKGROUND OF THE INVENTION

In manufacturing disk drives, servo tracks are typically written onto a disk, which servo tracks are utilized to guide movement of, and to position, read/write heads precisely. The servo tracks are meant to be concentric circles, and they can be written onto the disk using a servo track writer (STW) in a clean room environment.

In order to increase productivity during manufacturing, efforts have been made in the industry to use an STW to write servo track information onto multiple disks simultaneously. However, precision limitations cause misalignment between centers of disks and a spindle shaft of an STW, thereby resulting in eccentric servo tracks and non-repeatable run-out (NRRO) errors that deteriorate the performance of the disk drives.

In addition to the above-described problem, the write head of an STW used to write servo tracks does not always follow a perfectly circular path because of unpredictable pressure effects on the write head resulting from the aerodynamics of flight of the write head over the disk and from vibrations in a gimbal used to support the write head. The imperfect performance of the STW write head results in repeatable run-out (RRO) errors. Given the RRO errors, even if a disk drive read/write head were to follow the servo tracks perfectly, the read/write head would not follow circular paths, thereby resulting in undesirable performance of the disk drive.

In further addition to the above-described problems, aerodynamic and vibrational effects similar to those described above with respect to the STW write head (as well as other factors) hinder a read/write head of a disk drive from following servo tracks perfectly, thereby resulting in track-following errors which also cause undesirable performance of the disk drive.

One method for reducing the above-described errors is to utilize the read/write head of the disk drive itself to write the servo tracks so that differences of eccentricity and aerodynamic and vibrational effects between servo writing and track following are minimized. However, such a method limits productivity because only one disk drive head disk assembly (HDA) can be connected to an actuator for servo writing at a time, and it is not cost-effective if many actuators are needed. In order to increase productivity using this method, efforts have been made in the industry to stack multiple HDAs for simultaneous servo writing, but perturbation problems in lengthened pin pusher structures and HDA support structures render such efforts impractical.

In light of the above, there is a need in the art for a servo writing device that solves one or more of the above-identified problems.

### SUMMARY OF THE INVENTION

One or more embodiments of the present invention solve one or more of the above-identified problems. In particular, one embodiment of the present invention is a servo writing device that includes: (a) an actuator; (b) a first pushpin block that is coupled to a first side of the actuator and is adapted to drive a first head stack assembly during servo writing on a first disk; and (c) a second pushpin block that is coupled to a second side of the actuator and is adapted to drive a second head stack assembly during servo writing on a second disk.

### BRIEF DESCRIPTION OF THE DRAWING

FIG. 1 shows an exploded view of a servo writing device that is fabricated in accordance with one or more embodiments of the present invention;

FIG. 2 shows a side view of the assembled servo writing device shown in FIG. 1;

FIG. 3 shows a head stack assembly of a head disk assembly that is mounted on one pushpin block of a servo writing device that is fabricated in accordance of one or more embodiments of the present invention; and

FIG. 4 shows a block diagram of a servo writing system that is fabricated in accordance with one or more embodiments of the present invention.

### DETAILED DESCRIPTION

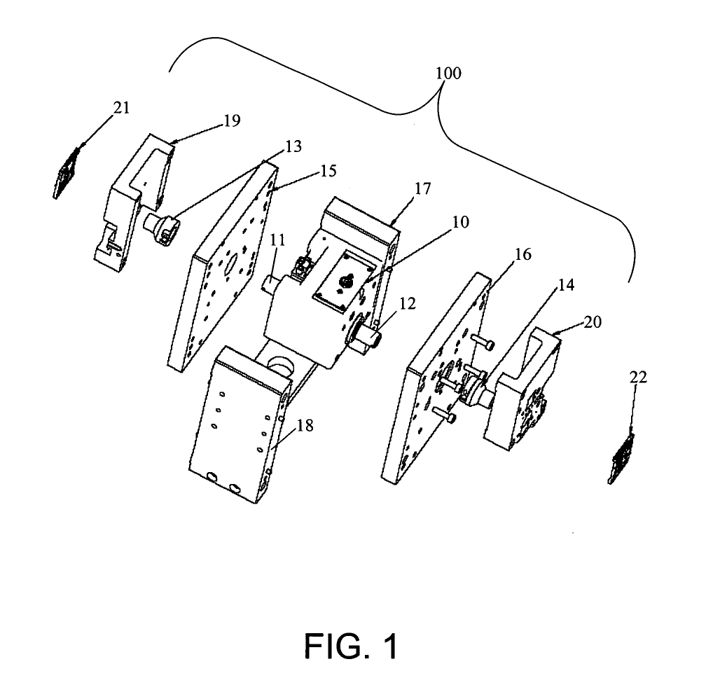

FIG. 1 shows an exploded view of servo writing device 100 that is fabricated in accordance with one or more embodiments of the present invention. As shown in FIG. 1, servo writing device 100 includes: (a) actuator 10; (b) first shaft member 11 which is coupled to a first side of actuator 10; (c) second shaft member 12 which is coupled to a second side of actuator 10; (c) first pushpin block 13 which, when servo writing device 100 is assembled, is coupled to the first side of 10 through first shaft member 11; and (d) second pushpin block 14 which, when servo writing device 100 is assembled, is coupled to the second side of actuator 10 through second shaft member 12. Further, when servo writing device 100 is assembled, and as will be described in detail below, first pushpin block 13 and second pushpin block 14 engage a head stack assembly (HSA) included in first head disk assembly 21 (first HDA 21) and an HSA included in second head disk assembly 22 (second HDA 22), respectively. In accordance with one or more embodiments of the present invention, actuator 10 is a rotary actuator (and is also known in the art as a motor or positioner) that, as will be described in detail below, actuates positioning of read/write heads carried by the HSAs included in first HDA 21 and second HDA 22, respectively, for servo writing. To do this, an actuating force provided by actuator 10 is transmitted through: (a) first shaft member 11 and first pushpin block 13 to first HDA 21; and (b) second shaft member 12 and second pushpin block 14 to second HDA 22.

In accordance with one or more embodiments of the present invention, servo writing device 100 further includes a support structure for supporting actuator 10. As shown in FIG. 1, in accordance with one or more embodiments of the present invention, servo writing device 100 includes first support plate 15, second support plate 16, third support plate 17, and fourth support plate 18 that enclose and support actuator 10. Further, in accordance with one or more embodiments of the present invention, servo writing device 100 also includes first HDA support assembly 19 and second HDA support assembly 20 that support first HDA 21 and second HDA 22, respectively.

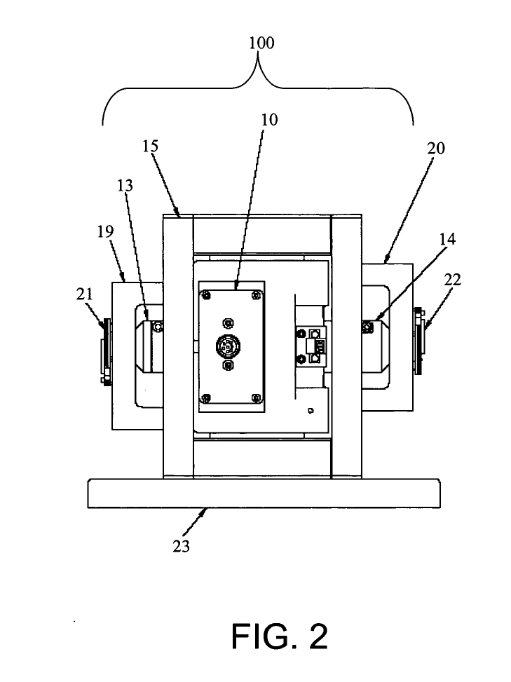

FIG. 2 shows a side view of assembled servo writing device 100 shown in FIG. 1. As shown in FIG. 2, servo writing device 100 is supported by base plate 23 with actuator 10 affixed thereto by first support plate 15 and second support plate 16. As further shown in FIG. 2, first HDA support assembly 19 and second HDA support assembly 20: (a) are affixed to first support plate 15 and second support plate 16, respectively; (b) at least partially enclose first pushpin block 13 and second pushpin block 14, respectively; and (c) support first HDA 21 and second HDA 22, respectively, during a servo writing process (or synchronized servo writing processes).

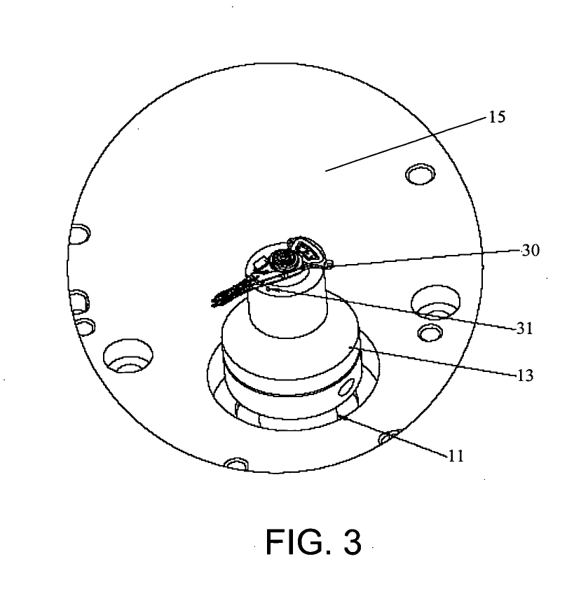

In accordance with one or more embodiments of the present invention: (a) actuator 10 simultaneously actuates first pushpin block 13 and second pushpin block 14; and (b) in response, first pushpin block 13 and second pushpin block 14 position read/write heads (not shown) disposed on the HSA included in first HDA 21 and the HSA included in second HDA 22, respectively, by engaging the HSAs (as illustrated in FIG. 3) which carry the read/write heads.

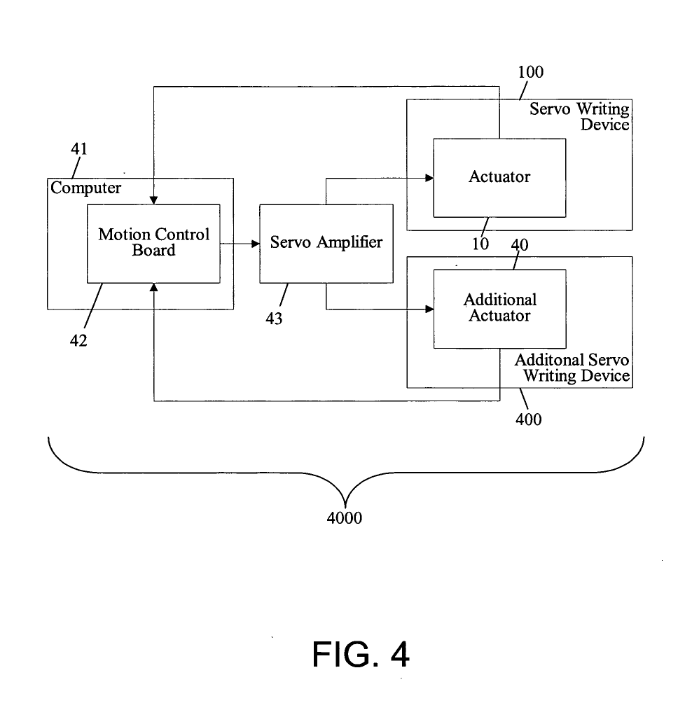

FIG. 4 shows a block diagram of servo writing system 4000 that is fabricated in accordance with one or more embodiments of the present invention. In accordance with one or more embodiments of the present invention, actuator 10 of servo writing device 100 is controlled by motion control board 42 that is plugged into a motherboard of computer 41, which motion control board 42 communicates with computer 41 through, for example and without limitation, an Industry Standard Architecture (ISA) interface. A suitable motion control board may be purchased together with actuator 10 (embodied, for example and without limitation, as a rotary actuator) in a “positioner package,” which positioner package also includes positioner software that is loaded onto computer 41. As is well known to one of ordinary skill in the art, suitable positioner packages can be obtained commercially from precision motor and controller suppliers that are well known in the art such as, for example and without limitation, ETEL, Inc. (www.etel.ch) of Schaumburg, Ill. However, a commercially available rotary actuator may require customization to enable it to actuate first pushpin block 13 and second pushpin block 14 (shown in FIGS. 1 and 2) simultaneously, since a typical, off-the-shelf, rotary actuator actuates only one pushpin block or one shaft. As is well known, suppliers are able to perform such actuator customization upon request, and, commercially available off-the-shelf products can be used to provide motion control board 42 and the positioner software.

As shown in FIG. 4, in accordance with one or more embodiments of the present invention, motion control board 42 receives positional information from actuator 10, which positional information is processed by computer 41 by running the positioner software. As a result, computer 41 sends a signal to motion control board 42 that causes it to transmit a control voltage to servo amplifier 43. In response, servo amplifier 43 amplifies the control voltage, and transmits it to actuator 10 to control motion of actuator 10. As well known in the art, servo amplifier 43 may be included in the above-mentioned positioner package. In accordance with one or more embodiments of the present invention, a power supply (not shown) is connected to servo amplifier 43, which power supply, in turn, supplies electric current to enable operation of actuator 10. In accordance with one or more embodiments of the present invention, motion control board 42 installed in computer 41 is connected to actuator 10 and servo amplifier 43 through computer 41 and cables which provide interfaces and connections between motion control board 42 and actuator 10 and between motion control board 42 and servo amplifier 43.

As shown in FIG. 4, in accordance with one or more embodiments of the present invention, servo writing system 4000 further includes at least one additional servo writing device 400, which servo writing device 400 includes additional actuator 40. Advantageously, this embodiment provides additional servo writing capacity. In accordance with one or more further embodiments of the present invention, additional servo writing device 400 includes components that are equivalent to the above-mentioned components of servo writing device 100 that are shown in FIGS. 1 and 2. Further, in accordance with one or more such embodiments of the present invention, additional actuator 40 and actuator 10 communicate with motion control board 42 and servo amplifier 43 using the same type of connections and interfaces. Further, in accordance with one or more embodiments of the present invention, servo writing system 4000 may include still further servo writing devices to enable such embodiments to perform servo writing on still further disks simultaneously.

In accordance with one or more embodiments of the present invention, computer 41 also runs servo writing software that is well known to one of ordinary skill in the art. As is well known, such servo writing software: (a) determines servo information to be written onto disks in, for example and without limitation, first HDA 21 and second HDA 22 of servo writing device 100; (b) controls spinning of the disks; and (c) controls writing of servo information by read/write heads, which read/write heads are positioned in response to output from the positioner software in the manner described herein. Further, in accordance with one or more embodiments of the present invention, the servo writing software controls spinning of the disks and writing of servo information through at least one servo track writing printed circuit board (STW PCB) (not shown) which is connected to computer 41 through, for example and without limitation, a USB interface and is connected to first HDA 21 and second HDA 22 through ribbon cables and pogo pins or through any one or a number of other connection schemes that are well known to one of ordinary skill in the art.

In accordance with one or more embodiments of the present invention, first shaft member 11 and second shaft member 12 are made of a stiff material such as, for example and without limitation, stainless steel, to minimize: (a) the magnitude of vibration (measured as mechanical Bodes or decibels in a manner that is well known to those of ordinary skill in the art); and (b) variation of the magnitude of vibration across a specified range of natural frequency values such as, for example and without limitation, 10 Hz to 100 KHz, for easier and better error compensation. In accordance with one or more further embodiments of the present invention, first shaft member 11 and second shaft member 12 include thereon off-the-shelf, and commercially available, position encoders (not shown) that are adapted to operate in conjunction with an off-the-shelf, and commercially available, measurement system of a type that is well known to one of ordinary skill in the art, to improve the accuracy of read/write head positioning by feedback control and error compensation.

In accordance with one or more embodiments of the present invention, first pushpin block 13 and second pushpin block 14 are made of stiff material such as, for example and without limitation, stainless steel, to minimize: (a) the magnitude of vibration (measured as mechanical Bodes or decibels in a manner that is well known to those of ordinary skill in the art); and (b) variation of the magnitude of vibration across a specified range of natural frequency values such as, for example and without limitation, 10 Hz to 100 KHz. Further, in accordance with one or more embodiments of the present invention, first pushpin 31 (shown in FIG. 3) and a second pushpin (on second pushpin block 14, and not shown) are made of relatively less stiff material such as, for example and without limitation, aluminum, to minimize wear of first head stack assembly 30 (shown in FIG. 3 and included in first HDA 21) and a second HSA (included in second HDA 22, and not shown) by contact with the pushpins. Dimensions of first pushpin block 13, second pushpin block 14, first pushpin 31, and the second pushpin that are suitable for use with various disk drive designs may be determined by one of ordinary skill in the art routinely and without undue experimentation.

FIG. 3 shows first HSA 30 included in first HDA 21 (FIG. 3 does not show the remainder of HDA 21 so that the operation of this embodiment of the present invention may be more readily and easily understood), which HDA 21 is mounted on first pushpin block 13 in accordance with one or more embodiments of the present invention. As shown in FIG. 3, first pushpin block 13 is coupled to first shaft member 11, which first shaft member 11 extends through an opening in first support plate 15. As one can readily appreciate from FIG. 3, in accordance with one or more embodiments of the present invention, during a servo writing process, first pushpin 31 of first pushpin block 13 engages first HSA 30 by pushing against a side of first HSA 30. Thus, in accordance with one or more embodiments of the present invention, the servo writing process takes place as follows. First, a voice coil motor of HDA 21 (not shown) causes a read/write head disposed on HSA 30 to move to an inner diameter of a disk of HDA 21 in a manner that is well known to those of ordinary skill in the art. Then, first pushpin 31 engages HSA 30 to drive its read/write head to various positions over the disk that are designated by the positioner software, i.e., various positions from the inner diameter/sections to outer diameter/sections of the disk. At the various positions, in response to signals generated by the servo writing software, the read/write head in first HSA 30 writes servo information onto the disk of first HDA 21. Finally, after servo writing is complete, the voice coil motor causes the read/write head to move from an outer diameter of the disk to a ramp (not shown) of HDA 21. In accordance of one or more embodiments of the present invention, a similar arrangement shown in FIG. 3 exists for second HDA 22 and second pushpin block 14 (both of which are shown in FIG. 2). Note, that although this description referred to read/write heads of a disk drive, further embodiments may utilize servo write heads.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

What is claimed is:

1. A servo writing device comprising:
an actuator;
a first pushpin block that is coupled to a first side of the actuator and is adapted to drive a first head stack assembly during servo writing on a first disk; and
a second pushpin block that is coupled to a second side of the actuator and is adapted to drive a second head stack assembly during servo writing on a second disk.

2. The servo writing device of claim 1 which further comprises a first shaft member that is adapted to couple the first pushpin block to the first side of the actuator and to transmit torque from the actuator to the first pushpin block.

3. The servo writing device of claim 2 which further comprises a second shaft member that is adapted to couple the second pushpin block to the second side of the actuator and to transmit torque from the actuator to the second pushpin block.

4. The servo writing device of claim 1 which further comprises a first head disk assembly which carries the first head stack assembly, and a first head disk assembly support structure which supports the first head disk assembly.

5. The servo writing device of claim 4 which further comprises a second head disk assembly which carries the second head stack assembly, and a second head disk assembly support structure which supports the second head disk assembly.

6. The servo writing device of claim 1 wherein the first head stack assembly comprises a head which writes servo information.

7. The servo writing device of claim 1 wherein the second head stack assembly comprises a head which writes servo information.

8. The servo writing device of claim 1 wherein the first pushpin block and the second pushpin block are adapted to drive the first head stack assembly and the second head stack assembly simultaneously.

9. A servo writing system comprising:
an actuator;
a first pushpin block that is coupled to a first side of the actuator and is adapted to drive a first head stack assembly during servo writing on a first disk;
a second pushpin block that is coupled to a second side opposite from the first side of the actuator and is adapted to drive a second head stack assembly during servo writing on a second disk; and
a motion control board that is connected to and operated by a computer to control motion of the actuator.

10. The servo writing system of claim 9 wherein the first pushpin block and the second pushpin block are adapted to drive the first head stack assembly and the second head stack assembly simultaneously.

11. The servo writing system of claim 9 further comprising:
a second actuator that is controlled by the motion control board;
a third pushpin block that is coupled to a first side of the second actuator and is adapted to drive a third head stack assembly during servo writing on a third disk; and
a fourth pushpin block that is coupled to a second side opposite from the first side of the second actuator and is adapted to drive a fourth head stack assembly during servo writing on a fourth disk.

12. The servo writing system of claim 11 wherein the first, second, third, and fourth pushpin blocks are adapted to drive the first, second, third, and fourth head stack assemblies simultaneously.
